(19) United States
(12) Patent Application Publication
(10) Pub. No.: US 2014/0193013 A1
(43) Pub. Date: Jul. 10, 2014

(54) HEARING AID WITH AN IN-THE-EAR COMPONENT

(71) Applicant: Oticon A/S, Smorum (DK)

(72) Inventors: Arne Lindbjerg PEDERSEN, Smorum (DK); Lars Steen CHRISTENSEN, Smorum (DK)

(73) Assignee: Oticon A/S, Smorum (DK)

(21) Appl. No.: 14/148,189

(22) Filed: Jan. 6, 2014

Related U.S. Application Data
(60) Provisional application No. 61/749,421, filed on Jan. 7, 2013.

(30) Foreign Application Priority Data
Jan. 7, 2013 (EP) 13150410.2

(51) Int. Cl. H04R 25/02

(52) U.S. Cl. CPC H04R 25/02
USPC 381/328

(57) ABSTRACT

According to the invention, a receiver-in-the-ear (RITE) hearing aid with an in-the-ear component is proposed, wherein the in-the-ear component has a customized shell fitted to an individual user's ear canal geometry and a receiver placed in the shell, and wherein the receiver is connected to a further hearing aid component by means of a lead connection. The in-the-ear component comprises a face plate connected to the shell. The face plate is arranged on a side of the hearing aid component that faces away from a tympanic membrane when in use. The face plate comprises a cable feedthrough that is attached to the face plate and that is covered by a cover plate.

The invention refers to a hearing aid having an in-the-ear or in-the-canal component, wherein the component has a custom-made shell that fits an individual user's ear canal geometry.

Hearing aids featuring an in-the-ear or in-the-canal component are known as receiver-in-the-ear (RITE) hearing aids having an in-the-ear component and a behind-the-ear component that are connected via a lead connection.

In order to achieve a good fit in the canal and good sound characteristics, in-the-ear components of a hearing aid may be provided with a custom-made shell having an outer geometry that corresponds to the geometry of an individual ear canal. Such customized shells are also called ear moulds. The ear mould comprises the receiver (loudspeaker) and, depending on the type of the hearing aid, further electric and electronic components.

Other electric and electronic components are placed in the behind-the-ear component. The behind-the-ear component and the in-the-ear component are connected via a lead connection. The in-the-ear component typically has a sound outlet that is facing a user's tympanic membrane when in use. On that side of the in-the-ear component that is facing out of the ear canal, the cable connection is extending to the behind-the-ear component.

Typically, the cable connection comprises at least two or more electric cables that are placed in a tube that encloses the cables and provides for a necessary amount of stiffness.

In order to best fit a hearing aid to an individual user's needs, hearing aids with a behind-the-ear component and an in-the-ear component are made modular so that the in-the-ear component and the behind-the-ear component can be separated from each other without soldering. Thus, a behind-the-ear component can be combined with one of a number of different in-the-ear components.

It is an object of the invention to provide a hearing aid with an in-the-ear component that can be fitted to a user's needs as good as possible.

According to the invention, the subject is achieved by a receiver-in-the-ear (RITE) hearing aid with an in-the-ear component, wherein the in-the-ear component has a customized shell fitted to an individual user's ear canal geometry and a receiver placed in the shell, and wherein the receiver is connected to a further hearing aid component by means of a lead connection. The in-the-ear component comprises a face plate connected to the shell, or alternatively the in the ear component is made as a one piece element with a hole at a proximal face thereof. The face plate or the proximal face with the hole is arranged on a side of the hearing aid component that faces away from a tympanic membrane when in use. The proximal face or face plate comprises a cable feedthrough that is attached to the face plate or proximal face and is covered by a cover plate.

In the following “face plate” refers that part of the in the ear component which faces away from the ear when the component is in use, whether the part be a usual face plate or it is an integral element shaped with the in the ear part.

The combination of a custom-made shell with a standard cable feedthrough and a cover plate covering the cable feedthrough in the face plate promotes a modular construction of the hearing aid, wherein a lead connection can be easily attached and detached to and from the in-the-ear component while, at the same time, providing a customized shell that, together with the face plate and the cover plate, provides an essentially closed housing that only has one major opening, namely a sound opening that allows sound to pass from the receiver in the shell to the tympanic membrane of a user.

Preferably, the cable feedthrough comprises a plug connector for receiving a jack of the lead connection. Thus, the connection between the lead connection and the in-the-ear component can be made a releasable plug-in connection.

The plug connector preferably comprises a socket plate that is arranged in a complementary-shaped opening or recess in the face plate. In such arrangement, the socket plate can be designed as a part of an electric connector. While the face plate can act as a mechanical support structure for the socket plate, the face plate may be mounted to the customized shell prior to mounting the socket plate to the face plate. The plug connector further preferably comprises a plurality of electrically conducting contact pins for contacting electric contacts of the jack of the lead connection. Thus, the jack of the lead connection can comprise a number of contact sleeves for contacting the contact pins and can be plugged on the plug connector.

The electrically conducting contact pins are preferably arranged in parallel to each other and preferably each extend in a non-perpendicular (oblique) direction with respect to a base plane of the plug connector. The base plane of the plug connector is e.g. defined by mounting surfaces that attach abutting surfaces of the face plate when the plug connector is attached to the face plate. Such arrangement of the contact pins allows for a plug-in connection that is inherently safe with respect to unintentional unplugging.

Alternatively, the cable feedthrough may comprise a feedthrough plate with fixation means for fixing an end of a tube of the lead connection to the feedthrough. Thus, the tube surrounding the cables of the lead connection can be securely attached to the feed-through, while the cables can be fed through the feedthrough and to the electric or electronic components in the custom-made shell or ear mould. Preferably, the fixation means comprises a blunt connected to the end of the tube. The “blunt” refers to a blunted end of the tube, whereby a blunting process has been used to provide a small bead or collar at the end of the tube which has a wider diameter than the tube itself. The blunting process is carried out using heat to melt the outermost part of the tube possibly followed by a shaping operation whereby the blunt is molded from the fluid or semi-fluid tube material.

Because the cable feedthrough is made separately from the face plate, a standard face plate can be provided for the two different types of feedthrough that are suggested herein, so that a suitable feedthrough can be chosen according to an individual user's needs.

The invention shall now be disclosed in more detail by way of exemplary embodiments as disclosed in the Figures. In the Figures:

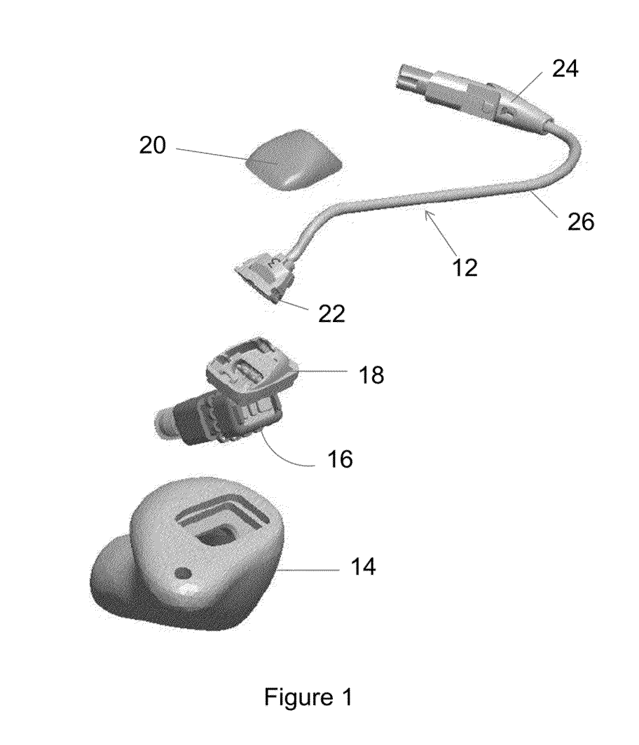

FIG. 1 is an exploded-view representation of a first embodiment of a hearing aid according to the invention.

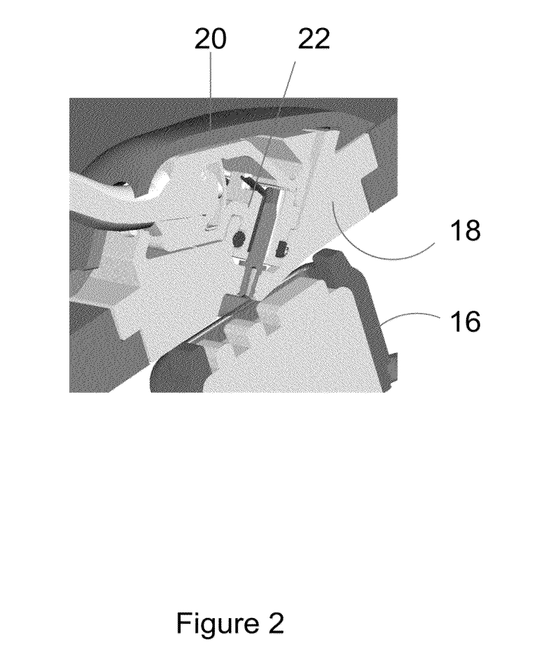

FIG. 2 is a detail of the hearing aid as shown in FIG. 1 in a semi-cutaway representation.

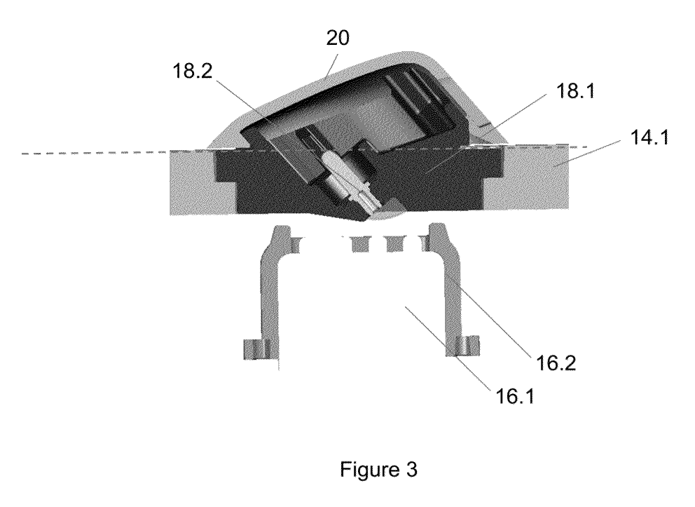

FIG. 3 is a cutaway representation of main components of the hearing aid illustrated in FIGS. 1 and 2.

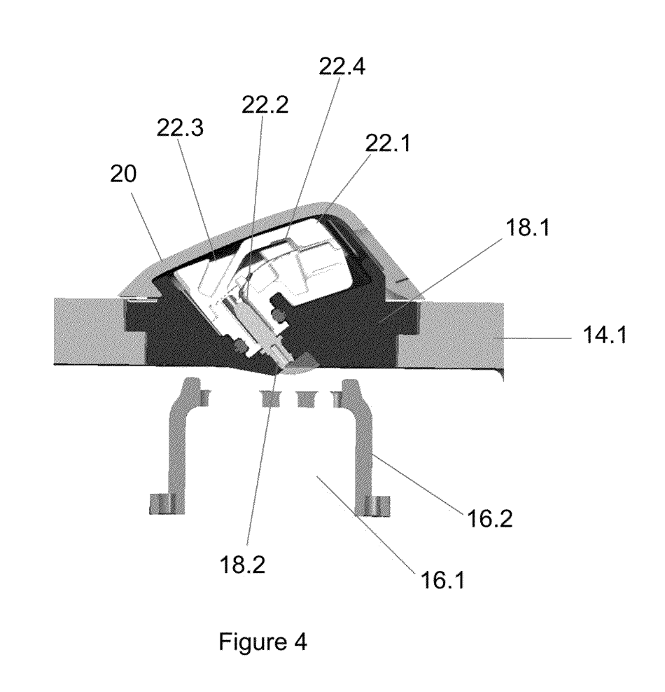

FIG. 4 is a representation similar to FIG. 4, additionally showing a jack of a lead connection in a cutaway representation.

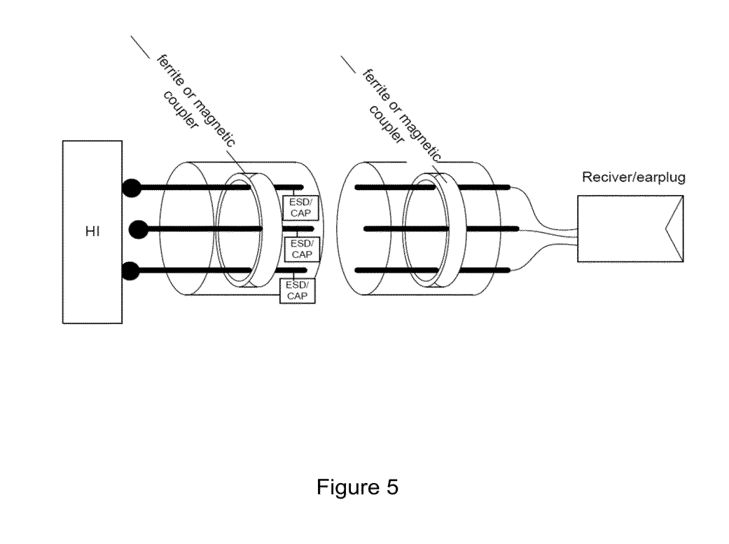

FIG. 5 is a schematic representation of a plug connector and jack with an inductor common mode moulded into the plug connector and/or the jack to improve EMI immunity.

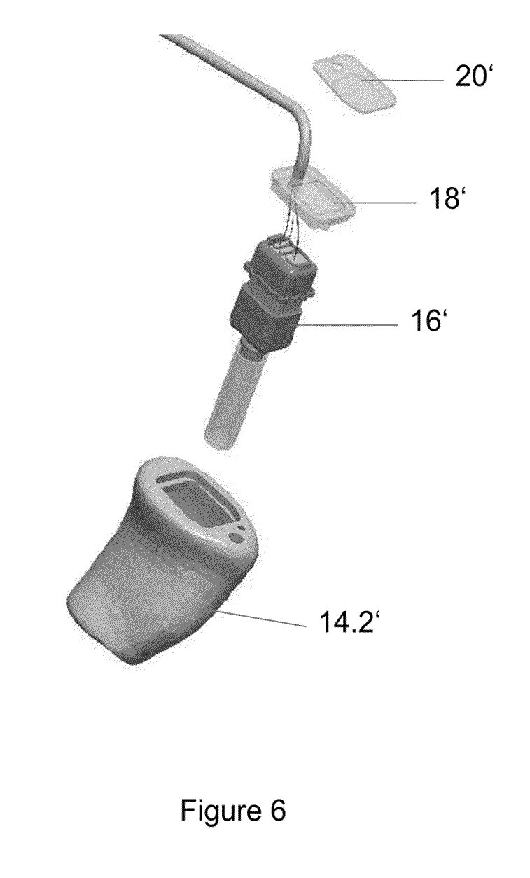

FIG. 6 is an exploded-view representation of a second exemplary embodiment of the invention.

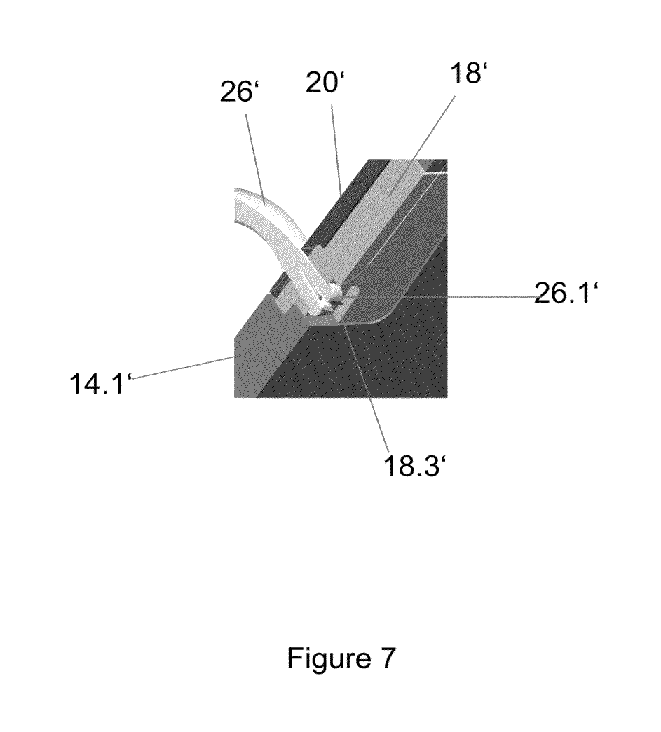

FIG. 7 is a representation of a detail of the embodiment of FIG. 6.

FIG. 1 discloses some components of a receiver-in-the-ear (RITE) hearing aid, in particular an in-the-ear component 10 and the lead connector 12. The in-the-ear component 10 comprises a customized shell or earmould 14 including a face plate (not represented), a receiver module 16, a plug connector 18 and a cover 20.

The lead connector 12 comprises a distal jack 22 and a proximal jack 24. The distal jack 22 fits onto plug connector 18, while the proximal jack 24 is configured to fit into a behind-the-ear component (not represented) of the RITE hearing aid. Between the proximal jack 24 and the distal jack 22 of lead connection 12, a tube 26 extends, which includes cables providing an electric connection between the proximal jack 24 and the distal jack 22. Tube 26 of lead connector 12 is made from sufficiently stiff plastic material, so as to help holding the behind-the-ear component in place.

FIGS. 2 to 4 illustrate details of plug connector 18 and jack 22. Plug connector 18 comprises a socket 18.1 that fits into an opening of face plate 14.1 of shell 14. Socket 18.1 carries contact pins 18.2 that are arranged in an angle of 30-50° with respect to a base plane of the plug connector. The base plane of the plug connector is indicated in FIG. 3 by a dashed line.

There are three contact pins 18.2 arranged in a row.

Distal jack 22 features three contact sleeves 22.2 that are arranged in a distal jack housing 22.1. The three contact sleeves 22.2 are configured to receive contact pins 18.2 of plug connector 18 when distal jack 22 is plugged onto plug connector 18.

Cables of the lead connection 12 are soldered to the contact sleeves 22.2. Cables from the receiver are soldered to contact pins 18.2. Thus, when contact pins 18.2 are received in contact sleeves 22.2, an electric connection between the receiver of the in-the-ear component and the electronics of the behind-the-ear component is established.

Socket 18.1 is glued into the opening of face plate 14.1 and thus fixed to face plate 14.1 and shell 14 in general. Jack housing 22.2 has a gripping hole 22.3 that is accessible if cover plate 20 is removed and allows to unplug jack 22 by pulling the jack 22 away from socket 18.1 preferably using an implement. In this way the Jack can be made very small.

The tube 26 of lead connection 12 has a blunt at its distal end which is received in an annular recess 22.4 of jack housing 22.1. Thus, cable 26 is prevented from being pulled out of distal jack 22.

When distal jack 22 is plugged onto plug connector 18, it can be covered by cover plate 20 which provides for almost completely closed outer surface of the in-the-ear plug component 10 of the hearing aid.

It should be noted that receiver 16.1 of receiver module 16 is partly enclosed by a sleeve 16.2 that is made from soft elastic plastic material and which serves as a sound isolating suspension for receiver 16.1. Suspension sleeve 16.2 preferably comprises two parts that can be slipped on receiver 16 at the proximal connector side and at the distal sound outlet side. In this description, the term “proximal” and “distal” are used in a way that all parts that are closer to a tympanic membrane of a user's ear are called “distal” and parts that face away from a user's tympanic membrane are called “proximal”.

To the distal part of suspension sleeve 16.2, the tube-like sound duct 16.3 is connected, which guides the sound from the receiver's 16 sound outlet to sound outlet opening or shell 14.2.

FIGS. 6 show an alternative embodiment, wherein the cables 28 of lead connection 12 are directly connected to receiver 16.1′. Correspondingly, cable feedthrough 18′ is not configured as a socket but merely serves for fixing a distal end of tube 26′ to cable feed-through 18′ by means of a blunt 26.1′ at the distal end of tube 26′. Blunt 26.1′ is received in a recess 18.3′ of cable feedthrough 18′. The cover plate 20′ ensures closure of the opening into the hearing aid and also provides the opportunity to ensure a colour match between the proximal surface of the hearing aid and the feed through opening.

FIG. 5 discloses the use of a ferromagnetic coupler or ring, which is provided on the electric leads in order to filter out high frequency noise in the receiver signal. Such a ferromagnetic ring may easily be incorporated into the socket 18 or jack 22 or the connector plate 18′. As schematically indicated in FIG. 5 the ferrite magnetic coupler may additionally or alternatively be installed at the hearing aid end of the lead connections.

1. A receiver in the ear (RITE) hearing aid with an in the ear component, wherein the in the ear component has a customized shell fitted to an individual user's ear canal geometry and a receiver placed in the shell and wherein the receiver is connected to a further hearing aid component by means of a lead connection,
wherein the ear component comprises a face plate surface, said face plate being arranged on a side of the hearing aid component that faces away from a tympanic membrane, when in use, said face plate comprising a cable feed through that is attached to the faceplate and that is covered by a cover.

2. The hearing aid according to claim 1, wherein the cable feed through comprises a plug connector for receiving a jack of the lead connection.

3. Hearing The hearing aid according to claim 2, wherein the plug connector comprises a socket plate that is arranged in a complementary-shaped opening (recess) of the face plate.

4. The hearing aid according to claim 2, wherein the plug connector comprises a plurality of electrically conducting contact pins for contacting electric contacts of the jack of the lead connection.

5. The hearing aid according to claim 4, wherein the electrically conducting contact pins are arranged in parallel to each other and each extend in a non-perpendicular di-rection with respect to a base plane of the plug connector.

6. The hearing aid according to claim 1, wherein the cable feed through comprises a feed through plate with fixation means for fixing an end of a tube that surrounds cables to the feed through plate.

7. The hearing aid according to claim 6, wherein the fixation means comprises a blunt connected to the end of the tube.

8. The hearing aid according to claim 1, wherein the cable feed trough is covered by a cover plate that closes a recess in the face plate and has a cable opening for a lead connection.

9. The hearing aid according to claim 3, wherein the plug connector comprises a plurality of electrically conducting contact pins for contacting electric contacts of the jack of the lead connection.

10. The hearing aid according to claim 2, wherein the cable feed trough is covered by a cover plate that closes a recess in the face plate and has a cable opening for a lead connection.

11. The hearing aid according to claim 3, wherein the cable feed trough is covered by a cover plate that closes a recess in the face plate and has a cable opening for a lead connection.

12. The hearing aid according to claim 4, wherein the cable feed trough is covered by a cover plate that closes a recess in the face plate and has a cable opening for a lead connection.

13. The hearing aid according to claim 5, wherein the cable feed trough is covered by a cover plate that closes a recess in the face plate and has a cable opening for a lead connection.

14. The hearing aid according to claim 6, wherein the cable feed trough is covered by a cover plate that closes a recess in the face plate and has a cable opening for a lead connection.

15. The hearing aid according to claim 7, wherein the cable feed trough is covered by a cover plate that closes a recess in the face plate and has a cable opening for a lead connection.
